(19) United States
(12) Patent Application Publication
(10) Pub. No.: US 2016/0048575 A1
(43) Pub. Date: Feb. 18, 2016

(54) SYSTEM AND METHOD FOR TOPICS EXTRACTION AND FILTERING

(71) Applicant: OSHREG TECHNOLGIES Ltd., Shfaim (IL)

(72) Inventors: Oren SHOHAM, Ra'anana (IL); Adi ESHKOL, Pardes Hanna-Karkur (IL); Alain NOCHIMOWSKI, Ra'anana (IL); Ofer WEINTRAUB, Hertzliya (IL)

(21) Appl. No.: 14/779,702

(22) PCT Filed: Mar. 24, 2014
(86) PCT No.: PCT/IL2014/050315

§ 371 Date: Sep. 24, 2015

(30) Foreign Application Priority Data
Mar. 24, 2013 (IL) 225487

(51) Int. Cl. G06F 17/30

(52) U.S. Cl. CPC G06F 17/30598; G06F 17/30528; G06F 17/3053; G06F 17/30882; G06F 17/30867

(57) ABSTRACT

The present invention discloses a method of searching, identifying and classifying relevant content topics associated with a content object. The method comprising the steps of: receiving an input of a given content object, extracting candidate topics including diverse set of themes from content items of at least one data network source related to the given content object, wherein the candidate topics are identified by leading keywords according to predefined rules, creating topics' candidate lists that are organized according to target profiles and/or categories, calculating relevancy ranking based on analyzing statistics of keywords distribution in content items, calculating Interest/Popularity ranking based on calculating usages' statistics of content items related to the topics in the data network source, and/or of topics keywords in different mediums of the relevant data networks and calculating qualification Ranking by integrating normalized relevancy ranking with normalized Interest/Popularity ranking. The receiving, extracting, extracting, and calculating are performed by at least one processor device.

### BACKGROUND

1. Technical Field

The present invention relates to the field of content selection/identification and filtering in a multimedia content provision service and system, and more particularly of selection/identification and filtering of content items related to content which were previously consumed by a user from the multimedia content provision service and system.

2. Related Art

PCT application No. WO200219155 discloses a system and method for determining of a text document's concepts based on a predefined concepts knowledge base, and concept matching functionality, in order to reduce/represent the text document's content.

U.S. Pat. No. 8,032,511B (Topix) discloses creating web pages and categorizing content of web pages generation by category.

PCT application No. WO200191348 (Intellibridge) discloses providing customized information to an aggregation of users, wherein information categories and topics are the same notion, and their relevancy to an aggregation of users is predetermined according to a survey results, in order to target general information service accessible through a network.

U.S. patent application No. US20120226696 discloses method for extracting keywords from web content , ranking the keywords and selecting sub set of keywords based on the ranking.

Descriptive data (metadata) regarding various objects such as movies, books, shows, music, goods, etc. exist in abundance. For users to benefit from the abundance of data there is a need to simplify the access to the descriptive data and to extract its essence, i.e.—its main themes, or topics. Also, there is a need to do so without bearing high costs of manual extraction.

The extracted themes have to be interesting, relevant to the object and diversified over several realms. Therefore, finding a way to automatically create relations between different objects using extracted topics is becoming a necessity.

In order to maximize the relevancy and variety of extracted topics in relation with a given content, we search to solve both following technical problems: maximize the initial population of potential topics candidates, and then select, among these candidates, a restricted number of topics of diversified categories.

### BRIEF SUMMERY

The present invention discloses a method of searching, identifying and classifying relevant content topics associated with a content object. The method comprising the steps of: receiving an input of a given content object, extracting candidate topics including diverse set of themes from content items of at least one data network source related to the given content object, wherein the candidate topics are identified by leading keywords according to predefined rules, creating topics' candidate lists that are organized according to target profiles and/or categories, calculating relevancy ranking based on analyzing statistics of keywords distribution in content items, calculating Interest/Popularity ranking based on calculating usages' statistics of content items related to the topics in the data network source, and/or of topics keywords in different mediums of the relevant data networks andcalculating qualification Ranking by integrating normalized relevancy ranking with normalized Interest/Popularity ranking. The receiving, extracting, extracting, and calculating are performed by at least one processor device.

According to some embodiments of the present invention the predefined rules include identifying keywords of words which are marked as hyperlinks within the at least one data network source;

According to some embodiments of the present invention the analyzing statistics include at least one of: counting number of content items which include said topics, counting number of content items which include said topics keywords as hyperlinks According to some embodiments of the present invention the extracting topics further includes identifying topics by leading keywords across multi languages data network sources.

According to some embodiments of the present invention the extracting topics further includes identifying topics by leading keywords across multiple different data network sources.

According to some embodiments of the present invention the calculating relevancy further includes scanning and analyzing through different types media services.

According to some embodiments of the present invention the calculating usages statistics of content items related to the topics in the data network source, and/or of topics keywords include at least one of: (i) queries keywords searching statistics; (ii) appearances in discussion sessions or news; (iii) advertising ranking and (iv) related content item reading popularity.

According to some embodiments of the present invention the calculating Interest/Popularity ranking further includes checking interest in cross media activity of different content type services.

According to some embodiments of the present invention the advertising ranking includes counting ad words selection or checking cost of keywords in ad words.

According to some embodiments of the present invention the selecting the top ranked topics form different categories or sub-categories creating blended lists of topics.

According to some embodiments of the present invention the cleaning up by excluding candidate topics according to at least one criterion: self-reference of the movies or movies contributors, reference to other movies and contributors, and stop words.

According to some embodiments of the present invention the method further comprises the step of excluding topics having relevancy rate bellow predefined threshold.

According to some embodiments of the present invention the method further comprises the step of excluding topics having popularity rate below predefined threshold.

The present invention provides, a computerized system having at least one processor for searching, identifying and classifying relevant content topics associated with a content object. The system is comprised of: an extraction module for selecting candidate topics including diverse set of themes from content items by scanning at least one data network source related to the content object, wherein the candidate topics are identified by leading keywords according to predefined rules, a categorization module for creating candidate topics' lists that are organized according to target profiles and/or categories, a relevancy module for calculating relevancy ranking based on analyzing statistics of keywords distribution within content items, a popularity module for calculating Interest /Popularity ranking based on calculating usages statistics of content items related to the topics in the data network source, and/or of topics keywords in different mediums of the data networks and a ranking module for calculating qualification Ranking by integrating normalized relevancy ranking with normalized Interest/Popularity ranking.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram of a topic extraction system having a topic qualification functionality, according to the present invention;

FIG. 1B is a high level schematic block diagram of a topic extraction method comprising a topic qualification method, according to the present invention;

FIG. 2 is a high level flowchart illustrating a candidate topic extraction method, according to some embodiments of the present invention.

FIG. 3 is a high level flowchart illustrating a topic Cleanup method, according to some embodiments of the present invention.

FIG. 4 is a high level flowchart illustrating a topic Categorization method, according to some embodiments of the present invention.

FIG. 5 is a high level flowchart illustrating a Relevancy Ranking method, according to some embodiments of the present invention.

FIG. 6 is a high level flowchart illustrating an Interest/Popularity Ranking method, according to some embodiments of the present invention.

FIG. 7 is a high level flowchart illustrating a Qualification Ranking method, according to some embodiments of the present invention; and

FIG. 8 is a high level flowchart illustrating a topic blending method, according to some embodiments of the present invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments and liable to be practiced or carried out in various ways. Also, it is to be understood that the phraseology and terminology employed herein is for the purpose of description and should not be regarded as limiting.

Prior to setting forth the background of the related art, it may be helpful to set forth definitions of certain terms that will be used hereinafter.

The term “data network source” as used herein in this application, is defined as organized content items which are accessible through communication network, such as website. For example, Critics reviews of movies, news on actors, reviews of users, blog posts or any other text that is related to entertainment or themes' (topics) description.

The term “content object” as used herein in this application, is defined as any multimedia item ,such as: video, audio recording, image, eBook etc. which is consumed by the system users.

The term “content item” as used herein in this application, is defined as any structured text which appears in a data network source, such as an article, a message, a post and a feed of a social network.

The term “Category” or “Sub category” as used herein in this application, is defined as context or subject of a topic. For example, category may be: people, events, places, companies and object types (e.g. electricity). For example, a Subcategory for people may be actors, politician, artists etc.

The term “target profile” as used herein in this application, is defined as any personal or customized profile of: users, groups of users, advertisers, and subject such as geographic location and gender.

The term “mediums of the data networks ” as used herein in this application includes at least one of search engines, discussion forums, social networks, or chatting platforms.

The present invention provides a system and method for searching, identifying, filtering, rating and classifying content items from multiple data network sources which are relevant to at list one given content item. The invention system and method purpose is to maximize the relevancy and variety of extracted topics in relation with a given content, by first searching and identifying and classifying maximum number of potential topics candidates which are relevant for the given content item, and at a second phase of the process ranking, filtering and selecting the most relevant topic that is classified per category or per target profile.

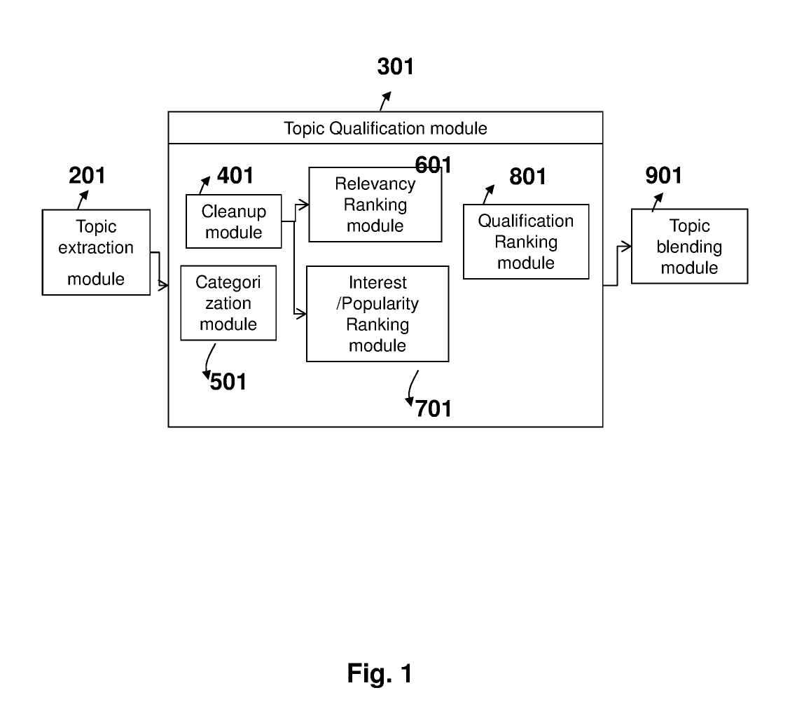

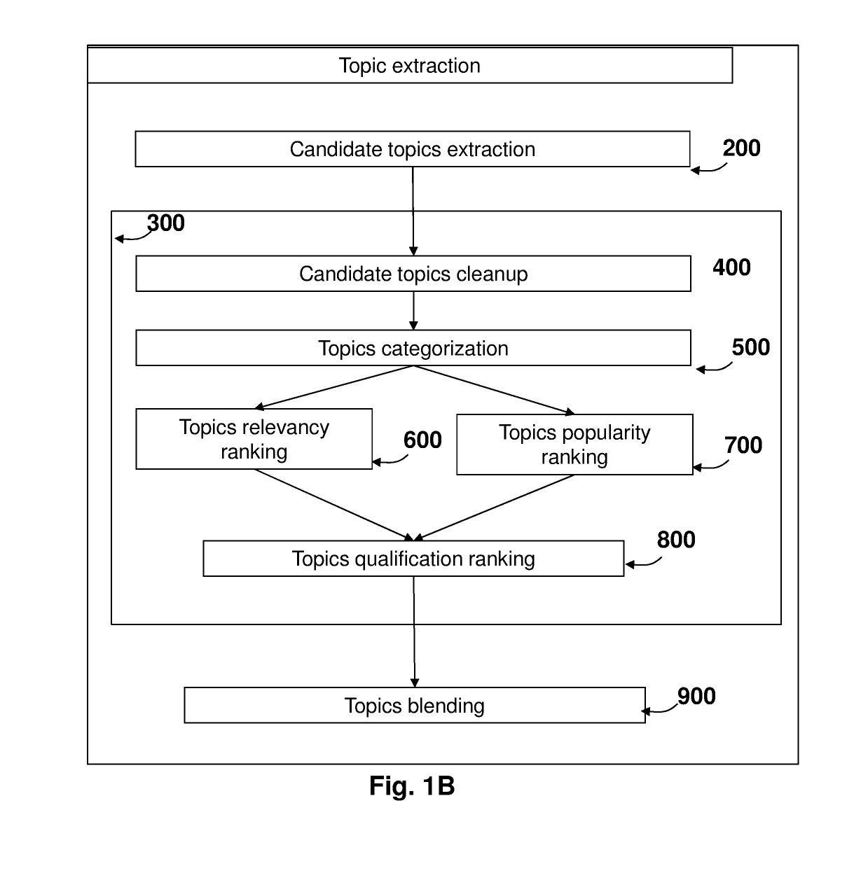

FIG. 1 is a high level schematic block diagram of a topic extraction system having topic qualification module 301, according to the present invention. The diagram exemplifies information processing flow between modules of the topic selection systems. FIG. 1B is a high level schematic diagram of a topic extraction process comprising a topic qualification process 300, according to the present invention. At its first phase, by the candidate topics extraction process 200 carried out by the candidate topics extraction module, candidate topics are searched, selected and extracted from at least one data network source according to pre-defined rules for analyzing data network sources and keywords selected and a list of candidate topics for a given content item is created.

According to some embodiments, at the next phase, the topics are qualified by the following qualification process 300, carried out by qualification module 301: cleanup process 400 carried out by cleanup module 401 for filtering non related topics keywords, categorization process 500 carried out by categorization module 501 for classifying the topics according to categories and target profiles, relevancy ranking process 600 carried out by relevancy ranking module 601 for rating topics based on analyzing content items in relation to the topics keywords, Interest/Popularity Ranking process 700 carried out by interest/popularity ranking module 701 for analyzing statistics of user usages of the topics keywords and/or related content items, and qualification ranking process 800 carried out by qualification ranking module 801 for creating integrated qualified ranking from the relevancy ranking and the popularity ranking.

In the last phase of the process according to some embodiments of the present invention, it is suggested to provide integrated list of topics by blending topics from different categories by the topic blending process 900 carried out by the blending module.

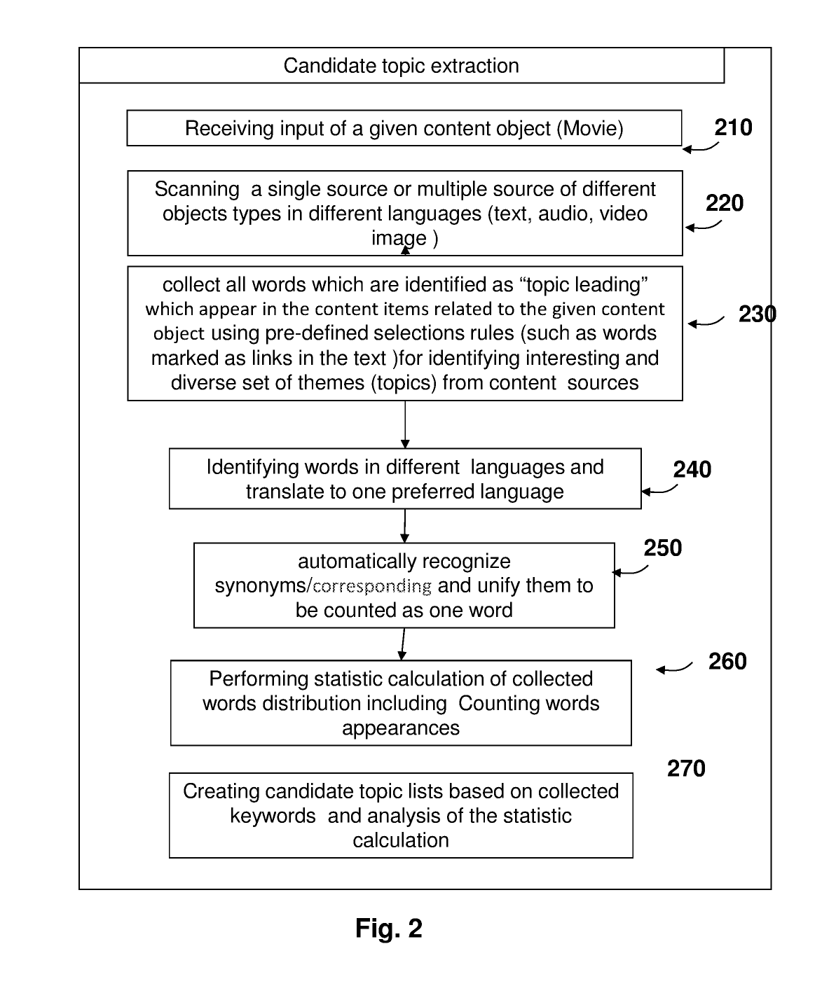

FIG. 2 is a high level flowchart illustrating a candidate topic extraction method 200, according to some embodiments of the present invention. At first stage of this process, the system receives an input of a given content object (step 210), at the next step, at least one content item, related to the given content object, of at least one data network sources such as Wikipedia is scanned (step 220). Throughout the scanning process words which are identified as “leading words” of topics are collected, which appear in the content items related to the given content object according to predefined rules (step 230). The scanning process may scroll through hyperlinks text, and optionally collect keywords of words which function as hyperlinks (step 230). Particularly, for example in the case of collaborative documentary services such as Wikipedia, the hyperlinks taken into account are internal hyperlinks, that is to say hyperlinks to content items in the same data network source. Optionally, words recognized as being the same term in different languages are unified to be counted as one keyword and may be translated to one predefined language (step 240), and synonyms or corresponding of the same term are unified to be counted as one keyword (250).

According to another aspect of the present invention the relevancy is evaluated by scanning analyzing through different types media services. For example the movie “Midnight in Paris” may be referenced in sites like “Pinterest” or “Instagram” where images are associated with a movie or topic. Such image analysis may yield topic relevancy to said movie (e.g. Fashion, artists, cars in the case of “Midnight in Paris”)

Throughout the scanning the distribution of the words within the content items is analyzed, including counting of the number of appearances of words within the content items (step 260). The analysis results are recorded, to be used at relevancy ranking process. At the end of the extraction process, lists of candidate topics are created based on the collected keywords (step 270).

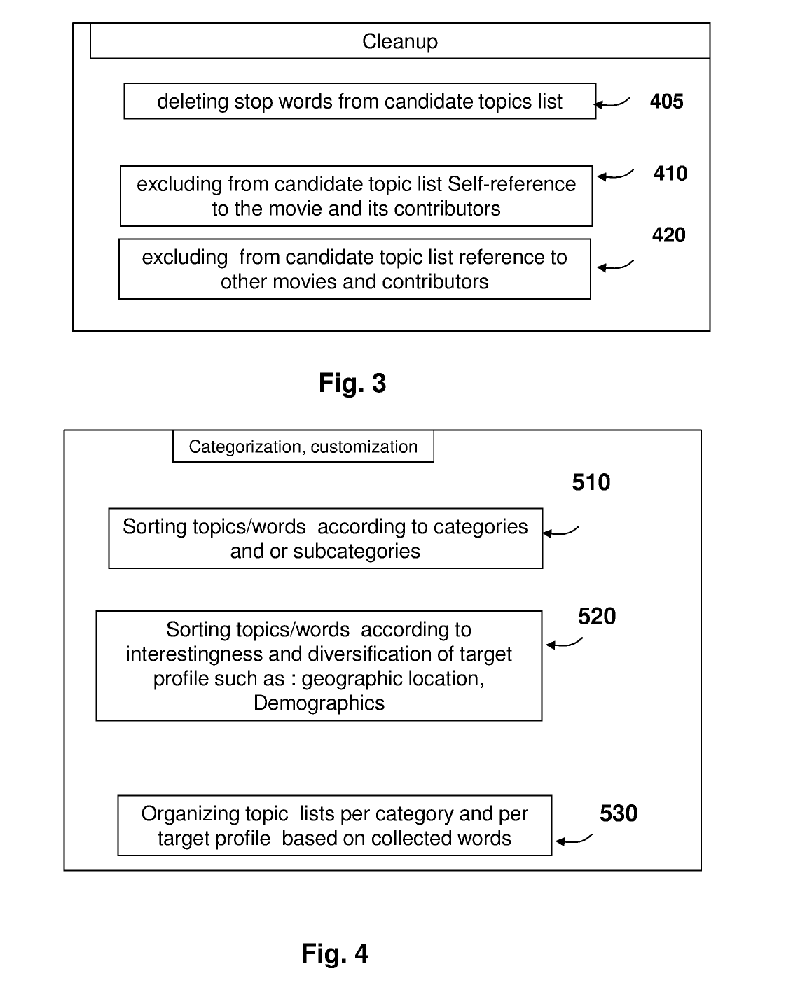

FIG. 3 is a high level flowchart illustrating a topic Cleanup method 400, according to some embodiments of the present invention. Through the process of cleaning up the candidate topics are excluded according to the following rules: stop words (step 405), self-reference of the movie or the movie's contributors, such as an actor director etc. (step 410), and reference to other movies and contributors (step 420).

FIG. 4 is a high level flowchart illustrating a topic Categorization method 500, according to some embodiments of the present invention. At this phase the potential topics are sorted and classified according to predefined categories and subcategories (step 510). A second classification of the topics is conducted according to target profiles of users, such as geographic location, gender, demographic and the like (step 520). Such classification may be important for the ranking phase 700. Based on said classification, the candidate topic lists are organized by categories and target profiles (step 530). According to other embodiments of the present invention the categorization step may take place at different phases of the process, for example after the qualification process 300.

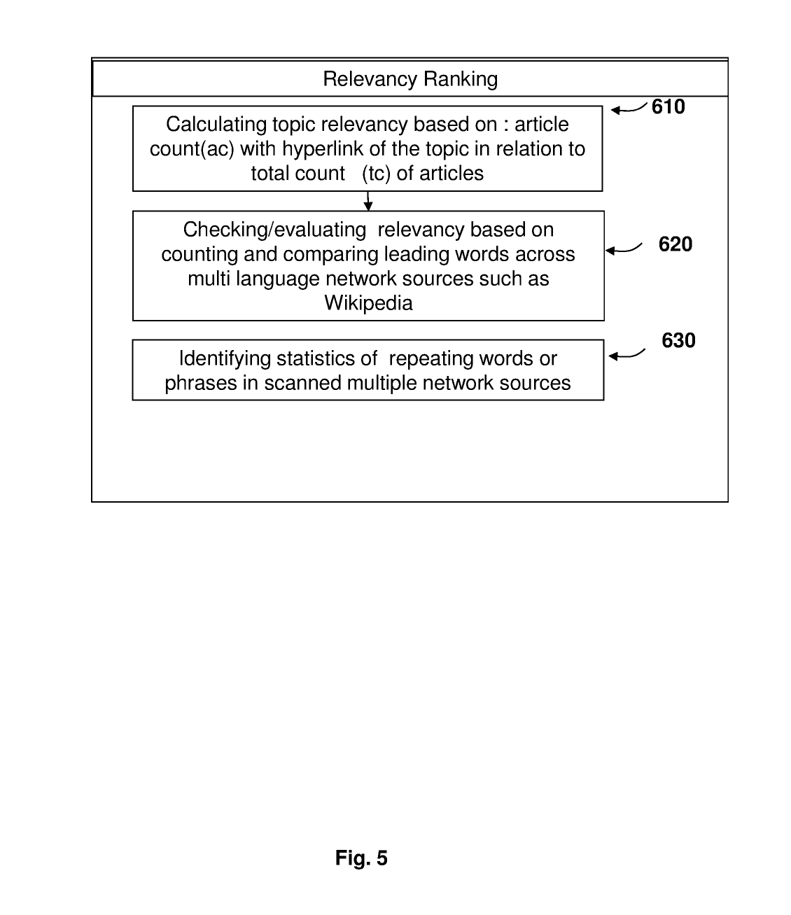

FIG. 5 is a high level flowchart illustrating a Relevancy Ranking method 600, according to some embodiments of the present invention. The relevancy ranking is achieved by performing calculation on the basis of the statistics analysis results of the keywords distribution. According to some embodiments, the calculation includes counting of the number of content items with hyperlinks of the topic key words in relation to the Total Counting (TC) of content items related to the content object (step 610).

According to another aspect of the present invention, the relevancy is evaluated by counting topic keywords appearances across multi language data network sources such as Wikipedia (step 620). According to another aspect of the present invention, the relevancy is evaluated by counting topic keywords or phrases repetitions across multiple different data network sources (step 630), such as blogs, user reviews, news and gossip, social networks, etc.

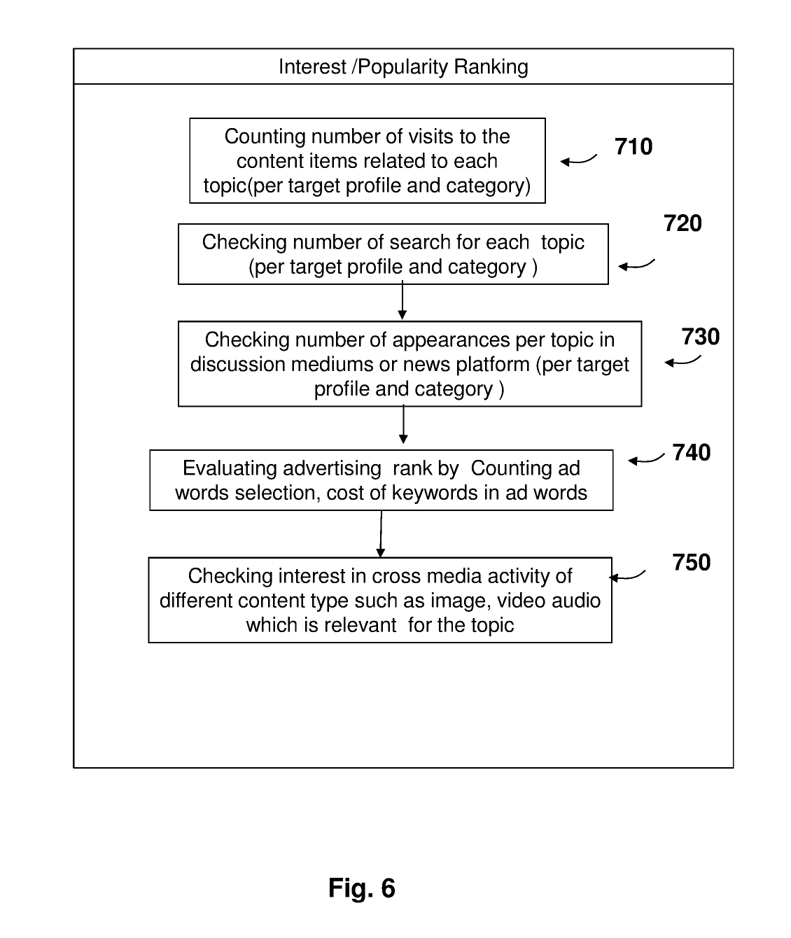

FIG. 6 is a high level flowchart illustrating an Interest/Popularity Ranking method 700, according to some embodiments of the present invention. This method is based on calculating usage statistics of content items related to the topics in the data network source, and/or of topics keywords in different mediums of the data networks: search engines, discussion forums, social networks, chatting platforms etc. The method may include one of the following steps or any combination thereof: Counting number of visits per topic at the data network source and/or at another website, (step 710), checking number of search queries and their frequencies including keywords of each topic, (step 720), checking number of appearances of each topic keywords in discussion mediums or news platform (step 730). Each of these steps can be optionally preformed per (profile and/or category/subcategory, when the categorization process takes place before the ranking.

According to some embodiments of the present invention the method 700 may include evaluating advertising rank by counting ad words selection or checking cost of keywords in ad words (step 740). According to another aspect of the present invention the method may include checking interest in cross media activity of different content type services such as image, video audio which is relevant for the topic (step 750).

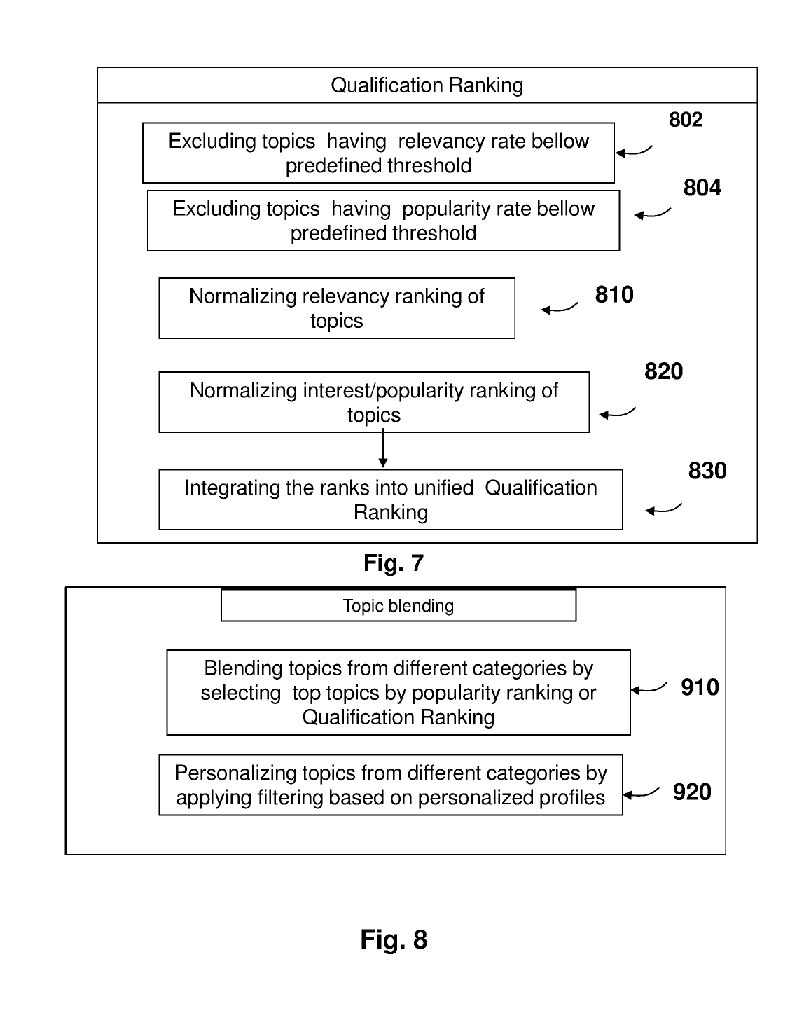

FIG. 7 is a high level flowchart illustrating a Qualification Ranking method 800, according to some embodiments of the present invention.

Optionally, at the final step of the process, topics that are having relevancy rate bellow predefined threshold are excluded (step 802).

Optionally, at the final step of the process, topics that are having popularity rate below predefined threshold are excluded (step 804)

The integrated Qualification Ranking is achieved by normalizing relevancy ranking of topics (step 810) and normalizing interest/popularity ranking of topics (step 820) to the same units, and unifying the ranking (step 830).

FIG. 8 is a high level flowchart illustrating a topic blending method 900, according to some embodiments of the present invention. The topic blending is achieved by selecting the top ranked topics from different categories or sub-categories (step 910). According to some embodiments of the present invention, it is suggested to provide personalized or customized topics' list from different categories by applying filtering based on target profiles. For example, this may be done by relating the number of top ranked topics of each category or sub-category to be assigned, to the target profiles.

1-27. (canceled)

28. A method of searching, identifying and classifying relevant content topics associated with a content object, the method comprising the steps of:
receiving an input of a given content object;
extracting candidate topics including diverse set of themes from content items of at least one data network source related to the given content object, wherein the candidate topics are identified by leading keywords according to predefined rules;
extracting topics' candidate lists that are organized according to target profiles and/or categories;
calculating relevancy ranking based on analyzing statistics of keywords distribution in content items;
calculating Interest/Popularity ranking based on calculating usages' statistics of content items related to the topics in the data network source, and/or of topics keywords in different mediums of the relevant data networks:; and
calculating qualification Ranking by integrating normalized relevancy ranking with normalized Interest/Popularity ranking.
wherein the receiving, extracting, extracting, and calculating are performed by at least one processor.

29. The method of claim 28, wherein the predefined rules include identifying keywords of words which are marked as hyperlinks within the at least one data network source;

30. The method of claim 28, wherein analyzing statistics include at least one of: counting number of content items which include said topics, counting number of content items which include said topics keywords as hyperlinks.

31. The method of claim 28, wherein the extracting topics further includes identifying topics by leading keywords across multi languages data network sources or multiple different data network sources.

32. The method of claim 28, wherein calculating arelevancy further includes scanning and analyzing through different types media services.

33. The method of claim 28, wherein calculating usages statistics of content items related to the topics in the data network source, and/or of topics keywords include at least one of: (i) queries keywords searching statistics; (ii) appearances in discussion sessions or news; (iii) advertising ranking and (iv) related content item reading popularity.

34. The method of claim 28, wherein the calculating Interest or Popularity ranking further includes checking interest in cross media activity of different content type services.

35. The method of claim 28, wherein the advertising ranking includes counting ad words selection or checking cost of keywords in ad words.

36. The method of claim 28, further comprising the step of selecting the top ranked topics form different categories or sub-categories creating blended lists of topics.

37. The method of claim 28, further comprising the step of cleaning up by excluding candidate topics according to at least one criterion: self-reference of the movies or movies contributors, reference to other movies and contributors, and stop words.

38. The method of claim 28, further comprising the step of excluding topics having relevancy or popularity rate bellow predefined threshold.

39. A computerized system having at least one processor for searching, identifying and classifying relevant content topics associated with a content object, the system comprising:
extraction module for selecting candidate topics including diverse set of themes from content items by scanning at least one data network source related to the content object, wherein the candidate topics are identified by leading keywords according to predefined rules;
categorization module for creating candidate topics' lists that are organized according to target profiles and/or categories;
relevancy module for calculating relevancy ranking based on analyzing statistics of keywords distribution within content items;
popularity module for calculating Interest/Popularity ranking based on calculating usages statistics of content items related to the topics in the data network source, and/or of topics keywords in different mediums of the data networks; and
ranking module for calculating qualification Ranking by integrating normalized relevancy ranking with normalized Interest or Popularity ranking.

40. The system of claim 39, wherein the predefined rules include identifying keywords of words which are marked as hyperlinks within the at least one data network source;

41. The system of claim 39, wherein the analyzing statistics includes at least one of: counting number of content items which include said topics and counting number of content items which include said topics keywords as hyperlinks.

42. The system of claim 39, wherein the extracting topics further includes identifying topics by leading keywords across multi languages data network sources or multiple different data network sources.

43. The system of claim 39, wherein calculating usages statistics of content items related to the topics in the data network source, and/or of topics keywords includes at least one of: (i) queries keywords searching statistics; (ii) appearances in discussion sessions or news, (iii) advertising ranking; (iv) related to the content item reading popularity.

44. The system of claim 39, wherein the calculating Interest or Popularity ranking further includes checking interest in cross media activity of different content type services.

45. The system of claim 39, further comprising a blending module for selecting the top ranked topics form different categories or sub-categories creating blended lists of topics.

46. The system of claim 39, further comprising cleaning up module for excluding candidate topics according to at least one criteria: self-reference of the movies or the movies' contributors, reference to other movies and contributors, and stop words.

47. The system of claim 39, wherein the mediums of the data networks include at least one of search engines, discussion forums, social networks, or chatting platforms.
